(19) United States
(12) Patent Application Publication
(10) Pub. No.: US 2018/0089595 A1
(43) Pub. Date: Mar. 29, 2018

(54) SYSTEM FOR MULTI-VARIABLE DIGITAL CONTENT INDEXING TOOL AND METHOD OF USE THEREOF

(71) Applicant: Trustable, Inc., Venice, CA (US)

(72) Inventors: John Martin, Venice, CA (US); Joseph Kenny, Alexandria, VA (US); Ravi Iyer, Los Angeles, CA (US); Joseph Maloney, Venice, CA (US); Benton Anderson, Marina Del Rey, CA (US)

(21) Appl. No.: 15/717,597

(22) Filed: Sep. 27, 2017

Related U.S. Application Data
(60) Provisional application No. 62/400,190, filed on Sep. 27, 2016.

(51) Int. Cl. G06N 99/00; G06Q 50/00; G06Q 30/02; G06F 17/27; H04L 29/08

(52) U.S. Cl. CPC G06N 99/005; G06Q 50/01; H04L 67/22; G06F 17/27; G06Q 30/0251

(57) ABSTRACT

The present application discloses systems and method for filtering digital source content for the processing and indexing of large volume of digital content by leveraging a multiple variable value-based system built upon selective intelligent processing of input data generated by multiple users or sources, each analyzed by using Natural Language Processing algorithm. More particularly, the present invention is related to a computer or machine implemented system for carrying out a system and a method of use thereof for the improvement of processing and indexing of large volume of digital content based on multiple variables. The system uses various interconnected modules to achieve the processing, filtering, indexing and ranking of large volumes of data, including, digital content created in the world wide web

This application claims the benefit of and priority from U.S. Provisional Application No. 62/400,190, MULTI-VARIABLE DIGITAL CONTENT INDEXING TOOL, SYSTEM AND METHOD OF USE THEREOF, filed on Sep. 27, 2016 which is fully incorporated herein by reference.

### FIELD OF INVENTION

The present disclosure relates to a multi-technology computer-implemented systems and method for filtering digital source content for the processing and indexing of large volume of digital content by leveraging a multiple variable value-based system built upon selective intelligent processing of input data generated by multiple users or sources, each analyzed by using Natural Language Processing algorithm. More particularly, the present invention is related to a computer or machine implemented system for carrying out a system and a method of use thereof for the improvement of processing and indexing of large volume of digital content based on multiple variables. The system uses various interconnected modules to achieve the processing, filtering, indexing and ranking of large volumes of data, including, digital content created in the world wide web.

The system and method of the present invention uses a value module (VM) configured to determine a number of value-based parameters and an association module (AM) configured to associate and align the value-based parameters to a number of social media markers. Next, a data module (DM), communicatively connected with the VM and the AM is configured to upload digital content data linked with each of said social media markers into a database. Next, a processing module (PM) communicatively connected with the Value Module (VM), the Association Module (AM) and the Data module (DM) is configured to use a Natural Language Processing (NLP) software to mine the database content by vectorization and associate key metrics, filter the data and index the content of the database. Finally a Ranking Module (RM) configured to use the key metrics alone or in conjunction with other indexing metrics is utilized to rank the processed digital content from the Processing Module (PM) and provide the ranked content in a third party database.

### BACKGROUND OF THE INVENTION

Data, including digital content such as news articles and other pieces of information residing within the world wide web, including in various social media sites, has increased exponentially. What was once manageable volume of content, manually generated by users is now a sea of automated content generated by multiple sources. Such data and content can become a challenge to manage and users often will have trouble finding content of interest within such data and content.

Currently, the internet has indexing tools provided by vendors such as Google (Google.com®). Using Google, user can enter searching keywords indicating their content of interest. Advertisers and content providers competing for consumer readership can often inundate a user with useless content. Therefore, consumers can find great value if given the opportunity to find content of interest without being subjected to unwanted solicitations from advertisers.

Social platforms like Facebook.com® or Twitter.com® can be used for indexing digital content. On social media, individuals can comment and attach themselves with content of interest. Some users will post comments of interests to their list of social contacts (friends on Facebook) while others will comment and express their personal views directly on the social media site. As a consequence, as some users endeavor to find and assemble useful content, others may simply log into a social networking site and benefit from social postings and comments. Further, social media sites also allows users to associate and agglomerate in groups and ultimately share efforts and content in a communal way. All of these are user driven rather than driven by content providers themselves.

Therefore, there is a need to provide improved computer-implemented tools using NLP algorithms which will allow digital content providers, such as websites, to filter, index, rank and deliver content to users by taking into consideration the characteristics of the users within the context of the social media world.

### SUMMARY

In an embodiment of the present invention, digital content is processed, filtered, indexed and ranked based on NLP algorithm in conjunction with context or other related information generated by a values-based system. By filtering users or a digital content source using values-based metrics and associating content of interest with the values and the users, the system creates an optimized algorithm to be used alone or as part of a group of indexing masks at a different source to help rank and associate content with the users. In addition, users can also be ranked and masked using the same values-based tools as above.

### BRIEF DESCRIPTION OF THE DRAWINGS

The following disclosure as a whole may be best understood by reference to the provided in the detailed description when read in conjunction with the accompanying drawings, drawing descriptions, abstract, background, field of the disclosure, and associated headings. Identical reference numerals, when found on different figures, identify the same elements or functionally equivalent elements. The elements listed in the abstract are not referenced but nevertheless refer by association to the elements of the detailed description and associated disclosure.

FIG. 1 is an illustration of the overall hardware architecture and network configuration and how users are empowered to use a system and method in accordance with an embodiment of the present invention.

FIG. 2 is a schematic illustration of the different internal hardware layers utilized to process information by the different hardware elements shown at FIG. 1 for use as part of the system and method in accordance with an embodiment of the present invention.

FIG. 3 is a schematic illustration of software, such as an App-based software used over a series of network servers to help enhance the software layer of the different hardware elements in accordance with an embodiment of the present invention.

FIG. 4 is a screenshot of the implementation of a values-based algorithm on a news generating site for users in accordance with an embodiment of the present invention.

FIG. 5 is a screenshot of the close-up illustration of a user-friendly graphical user interface (GUI) to help users define their own values in order to further improve the values-based indexing algorithm when applied to the html interface as shown in FIG. 4, in accordance with an embodiment of the present invention.

FIG. 6 is a screenshot of the mask values given to one of the answers of the interface shown in FIG. 5, in accordance with an embodiment of the present invention.

FIG. 7 is a screenshot of a possible values mask in accordance with an embodiment of the present invention.

FIG. 8 is an flow-chart illustration of a new site collection and scoring algorithm in accordance with an embodiment of the present invention.

FIG. 9 is a flow-chart illustration of filtering algorithm technology from research to engagement score in accordance with an embodiment of the present invention.

FIG. 10 is a flow-chart illustration of an algorithm for extracting values markers and predicting most engaging content by value type in accordance with an embodiment of the present invention.

### DETAILED DESCRIPTION

For the purposes of promoting and understanding the principles disclosed herein, reference is now made to the preferred embodiments illustrated in the drawings, and specific language is used to describe the same. It is nevertheless understood that no limitation of the scope of the invention is hereby intended. Such alterations and further modifications in the illustrated devices and such further applications of the principles disclosed and illustrated herein are contemplated as would normally occur to one skilled in the art to which this disclosure relates.

Description of the Structure/Hardware—Software

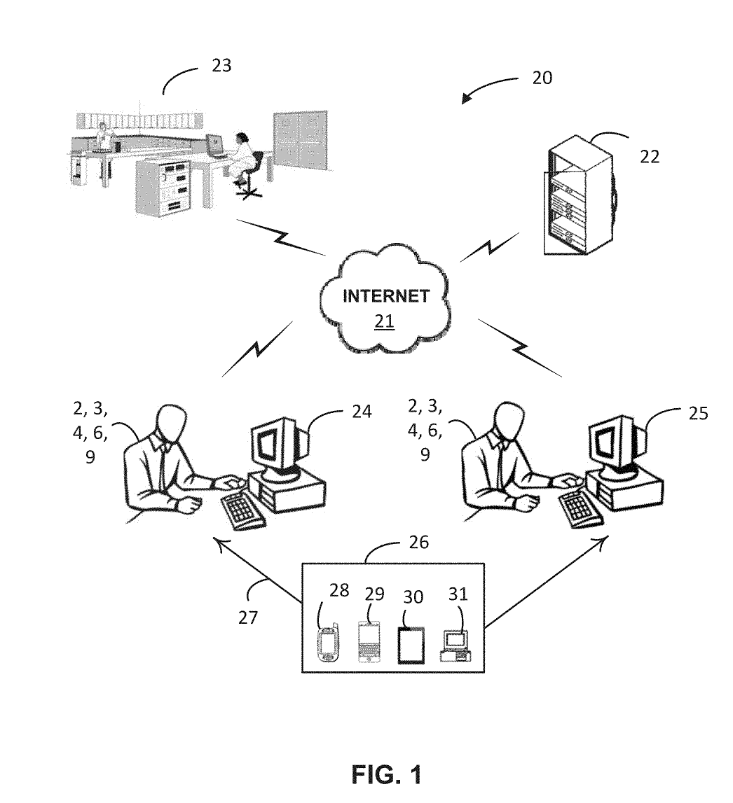

FIG. 1 is a schematic illustration of possible hardware used in a network configuration. In the early 1990s, during the advent of the world wide web and the internet, few were familiar with the general interconnectivity of the hardware elements used in a platform 20 or system. To enable patent applications, description of the interconnectivity of these elements became necessary. With time, those of ordinary skill in the art realized how each of these various elements of hardware and/or software operated to produce an unified networked system. To help with this disclosure, what is described hereafter is one configuration of how different elements communicatively connected with each other through a network in the present invention.

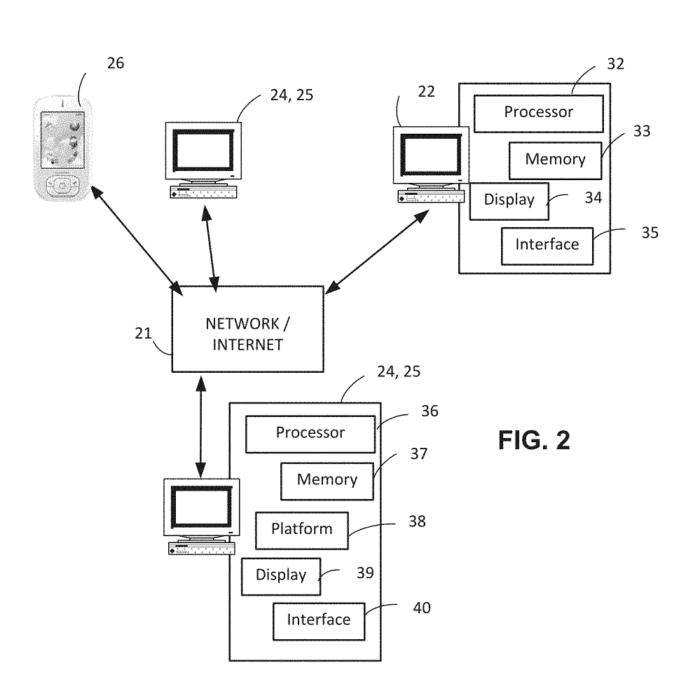

FIG. 2 shows how the internet 21 can function as a network by using, for example, the HTML protocol. Other networks, such as wireless networks, internal networks, or other non-html networks can also be contemplated. As the current platform is expanded with new technology, one of ordinary skill will know that the concepts shown herein can be applied to other networks using such new technology over the internet and other wireless networks.

FIG. 2 is a high-level schematic of the different internal hardware layers used to process information by the different hardware elements shown in FIG. 1 according to an embodiment of the present invention. FIG. 2 further illustrates a remote data server 22, used to store data remotely which can be accessed by any third-party software application. For example, in recent years cloud based computing allows for more fluid data management by relying on a network of servers 22 located at different physical locations around the world. As shown, different rooms 23 can be connected to the internet or similar network to help manage the system, offer users rights and manage the flow of data through the network.

In FIG. 2, different parts of hardware 24, 25 are in turn connected to the internet 21 using their own communication protocols in order to provide network access to a large number of users. As shown, the users may be individuals 2, 3, 4, 6 or 9. While the illustration shows desktop computers 24 and 25, over time users have become more familiar with less bulky systems and equipment capable of accessing the internet 26. Smartphones now offer their owners full internet surfing capabilities through browsers and double capacity transceivers.

In an embodiment, as further illustrated in FIG. 2, users 2, 3, 4, 6 and 9 can use a desktop 31, a tablet 30, a smart phone 29 or a regular mobile phone 28. In each case, the users 2, 3, 4, 6 and 9 simply connect 27 the device 26 using access and password provided on a software layer. What is not described but is known is how the different ports and communication protocols interconnect using normal connectivity technology. For example, modern tablets can connect through wireless connection, data connection over phone networks, Bluetooth® or by using any other standard data transfer protocol.

In an embodiment, each of the devices 26 in FIG. 1 can host and empower multiple types of software to operate within these devices alongside (when needed) phone communication. As further illustrated, the different elements 22, 24, 25 and 26 connect to the network 21. Each of these devices has at least one processor 32, 36 which requires memory 33, 36 to operate. The memory of each of the devices contain written software instructions and each of the devices relies on multiple layers of hardware technology which operates to empower ports, clocks and other key features including providing the capacity to run programs in memory and then execute the program to generate outputs to be processed by the system. These devices also generally have ad display 34, 39 of one type or another to interact with the user, and also have an interface 35, 40 of one type or another such as a keyboard or a mouse, to help exchange information with the user.

As further illustrated in FIG. 2, the platform 38 or executed software used in the current invention is shown on the device 24, 25. This is designed to illustrate software applications executing on the device 24, 25 for one or multiple use. Such description while broad and general is sufficient to empower one of ordinary skill to understand how the below-described system will be implemented without undue experimentation and testing.

Recently, with the expansion of connectivity to hand-held portable devices, software which once was confined to desktops or servers now have migrated to these devices. In fact, a remote store on a server houses multiple “Apps” (an executable file in .app format) which can be uploaded directly by a user into the memory of a portable device for execution. Most of these Apps then connect wirelessly to a remote server where the main software application resides and operates. These Apps often serve as satellite software capable of interacting with a remote base for multiple functions.

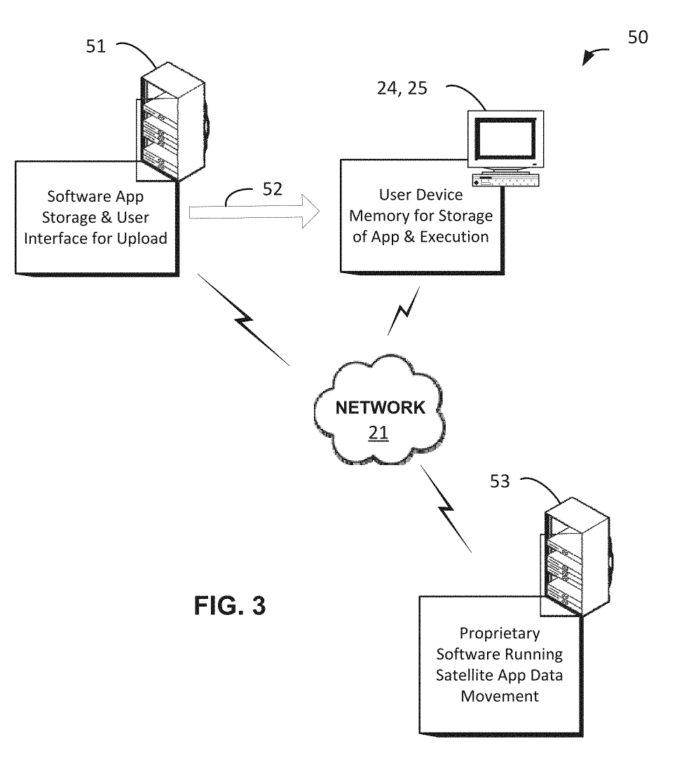

FIG. 3 is a schematic representation of how software, such as an App-based software can be used over a series of network servers to help enhance the software layer of the different hardware elements shown at FIG. 1 according to an embodiment of the present disclosure. As for the above-suggested embodiments, this one is simply illustrative and not designed to limit the platform in any way.

Apps, once they are programmed, are uploaded using an online portal onto a service provider, for example, the AppStore® from Apple®. As further illustrated in FIG. 3, users have access to a server 51 via the network 21 and, using their own devices, upload the App 52 required from the server 51. Once added to the memory of the device 24, 25, it will be executed and an icon-based interface will help a user launch the App locally. Using the network 21, once the App is launched, the software App connects to a second remote server 53 where data stored on the main software executes and communicatively connects with other parts of the system. Being an evolving technology, the process of sharing and managing Apps locally and remotely will evolve with time.

Currently, many software programs use a local HTML browser installed on the computer, along with their associated displays and interfaces, for example tablets, cell phones, portable or fixed computers with a commercial browser tool such as Internet Explorer® or Mozilla® to exchange information for the most part in the form of HTML script and data linked with the HTML script and display based on the format of the browser. The platform software 8, while programmed in any of multiple programming languages, relies on any one of multiple database tools, and can be made to read and generate content that can be accessed by the remote HTML browsers.

Description of Value Type Marks

To better understand how a values-based indexing system or tool works, it is important to provide some guidance on the concept of values. To better understand values-based system, the system can be arbitrarily classified into a handful of categories (six categories in the present invention) and the categories can be associated with different qualities, attributes, or preferences. A person of ordinary skill in the art will appreciate that while one method of structuring is described here, what is contemplated is any mode of structuring of these types of parameters.

Human mind is complex. Primarily, there are two ways by which information about the surrounding world is processed by a human brain. First, is through emotions and intuitions (the right brain). Second is through intellect and logic (the left brain). As will be discussed below, whether an individual is processing the information through the right (emotions and intuitions) or left (intellect and logic) part of the brain is aligned with the value based markers of the present invention.

In an embodiment, the value types are all based on decades of psychological research and each of the six (6) basic Trustable value types, Analysis, Achievement, Loyalty, Empathy, Universalism and Exploration are detailed below along with a short description of content that resonate with these individuals as well as some well-known people that aligns with such values. While one set of six values is given, one of ordinary skill will recognize that this system and tool can be created using different types of underlying values. A mathematical way of representing these values requires a sum of each to be normalized to 1.

Category 1: “Analysis” 86 as shown in FIG. 7.

Individuals who value “Analysis” prefer to understand the world through the left brain approach. They tend to think linearly and systematically, carefully considering evidence rather than trusting their guts. Content that aligns with this type of value is characterized more by style than by substance. Information or news articles can be dissected from a more analytical viewpoint under this approach. Stories about individual people are potentially less interesting to this group as compared to statistical trends. Data or information that illuminates a societal trend through statistical analysis (e.g. anything from fivethirtyeight.com or the NY times data journalism group) or a more systematic explanatory tone (Vox or Quartz) is more interesting to this group, as these individuals want to understand the world, rather than empathize with it. Few examples of individuals who align with this type of value would be Richard Dawkins, Bill Gates, Nate Silver, the statistician, or anyone who is considered to potentially be somewhat autistic in their orientation.

Category II: “Achievement” 91 as shown in FIG. 7.

Individuals who value “Achievement” admire success, accomplishment and the hard work and ingenuity that often leads to this success. Status is more likely to be important to this group and challenges which few others have achieved appeal to this group more than common achievements of general population. These individuals are sometimes more able to sacrifice short-term enjoyment in order to achieve something that enhances their resources and/or status in the longer-term.

Content that aligns with this type of value is characterized by stories of the people, places, and things that are associated with a highly successful lifestyle. Business news, especially news that celebrates personalities driving next generation business trends, is interesting to this group. Stories about how individuals were able to overcome odds and create successful businesses through a combination of skill, luck, and hard-work would resonate well with groups aligned with such value. These individuals like to read about people who do well in life, with the idea and aspiration that they could someday emulate characteristics of similar successful individuals. Few examples of individuals who align with this type of value would be Steve Forbes, the businessman, or libertarians like Ron Paul & Ayn Rand.

Category III: “Loyalty” 90 as shown in FIG. 7.

Individuals who value “Loyalty” are embedded within their the pre-set social groups and are willing to subsume their individual desires to the betterment of such groups. They respect the customs and traditions of these groups as these customs help improve group cohesion, which is important to these individuals. They believe in respecting and deferring to legitimate authority figures and are more likely to be swayed by messages from experts or celebrities. These individuals are concerned about law and order and security issues. They are very generous, but tend to concentrate this generosity toward people close to them.

Content that aligns with this type of value is characterized by news stories about law and order, especially content that is in close geographical proximity to where they reside. News about terrorism or articles about true crime and history that aligns with their thinking is of much interest to this group. Patriotism and stories that have a group loyalty theme would appeal to this group as well. Few examples of people who align with this type of value would be Ted Cruz, the soccer Dad (men tend to typify this more than women), Clint Eastwood, NRA members and other Law and Order types.

Category IV: “Empathy” 89 as shown in FIG. 7.

Content that aligns with this type of value is characterized by news articles having a human element and which emphasizes empathy and feelings over a formal logical argument. Any big news story where the human element is most prominent would be of interest (e.g. Netanyahu's personal life story) as would anything that is primarily touching/emotional (e.g. stories of people helping others, such as rescue mission in distressed parts of the world). News stories that make one feel are preferred to stories that make one think. Few examples of people who align with this type of value would be Mahatma Gandhi, the religious left, or a suburban Mom.

Category V: “Universalism” 88 as shown in FIG. 7.

Individuals that value “Universalism” are concerned about equality, social justice, and the welfare of people far removed from oneself, extending even to animals and the environment. These individuals care about people they never met such as the poor, homeless and hungry, regardless of whether those individuals are part of their group or not. They believe in an equal playing field and can harbor some resentment towards wealthier people.

Content that aligns with this type of value is characterized by news articles about foreign aid and helping people around the world (e.g. during natural disasters) would interest this group as well as stories about the environment and/or animal welfare. Stories about how average people are able to challenge the larger, more powerful organizations (e.g. fast-food workers strike) would be of interest to such individuals. Few examples of people who align with this type of value would be Elizabeth Warren, socialists, greenpeace activists, or anyone who is quite associated with fighting for the poor and weak.

Category VI: “Exploration” as shown as 87 on FIG. 7.

Individuals that value “Exploration” enjoy discovering and finding new opportunities. They appreciate diverse experiences, in part for the novelty and stimulation that comes from trying something new. They are more likely to travel and engage in extreme sports. They want to try every restaurant in a neighborhood and are more likely to live in a dense urban area where there is more to explore.

Content that aligns with this type of value are materials that highlight changes in the world, such as new technologies and new societal memes. Reading about news that concerns safety or law and order is of less interest to such group. The latest information from SXSW or news about Apple's products are stories that would be of interest to this group. Few examples of individuals who might fall into this group include Elon Musk, GoPro founder Nick Woodman, the adventure traveler, or the explorer.

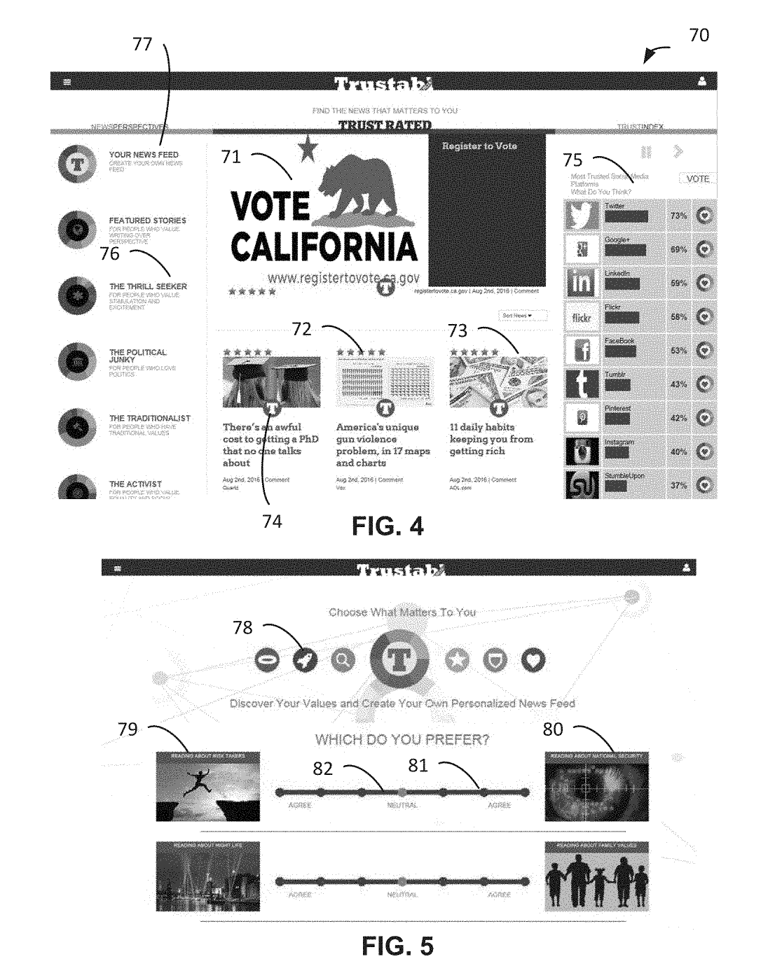

FIGS. 4-7 further illustrate how content, including questions, items, news articles, and more are rated by different people with different value characteristics. Each color in the circle represents a particular value type and the relative size of each color represents the relative importance of that value. Representing values in a this format demonstrates that each individual has some attraction to each value and the relative importance of each value changes depending the particular individual asked.

In an embodiment, as illustrated in FIGS. 4-7, some values have a natural tension with other values, so they are depicted opposite the other values on the circle, while other values have similar motivational components and so are displayed next to each other in the circle. Indeed, many people are better described at the intersection of two value types rather than a single value type.

Description of a Sample HTML Platform Using these Values.

FIG. 4 illustrates a sample webpage 70 where content is displayed to a user over an HTML formatted platform and browser. As further illustrated in FIG. 4, the top of the webpage 70 is the ordinary introduction of the technology using login and menu as known in the art. Next, data (most trusted) can be displayed 71 using this technology as will be described below. Secondary articles 72, 73, and 74 can be displayed which will allow a user to select a preferred story. In cases where a user is unknown, the selection of one of these stories, the ranking using a star system or the push of the “T” button to push this content to social media or any other external source results in the generation of a selection of values and identity of the user.

In an embodiment, if a user selects a story ranked with a highest score in Analysis, the user will be given such an attribute by filtering and some of the content on the page will dynamically evolve to adapt to the choice of the user. As further illustrated in FIG. 4, a user 77 is given simple to understand terms (e.g. the thrill seeker 76) that in fact is pre-associated with the values mask as described above.

In an embodiment, a user can also indicate a choice of likeness of one of multiple sources 75 which in turn is internally associated with the values mask shown above. For example, if Facebook™ is the most “achievement” platform, a user who indicate likeness of this will be ranked accordingly and be given indexed choices more likely to be optimized with this value.

FIG. 5 illustrates one of multiple type of interface which can be used to help associate with the user of different values. In this example, a user is given visual stimuli in the form of two images 79, and 80 and to reinforce these images a narrative like (a) reading about risk takers, and (b) reading about national security.

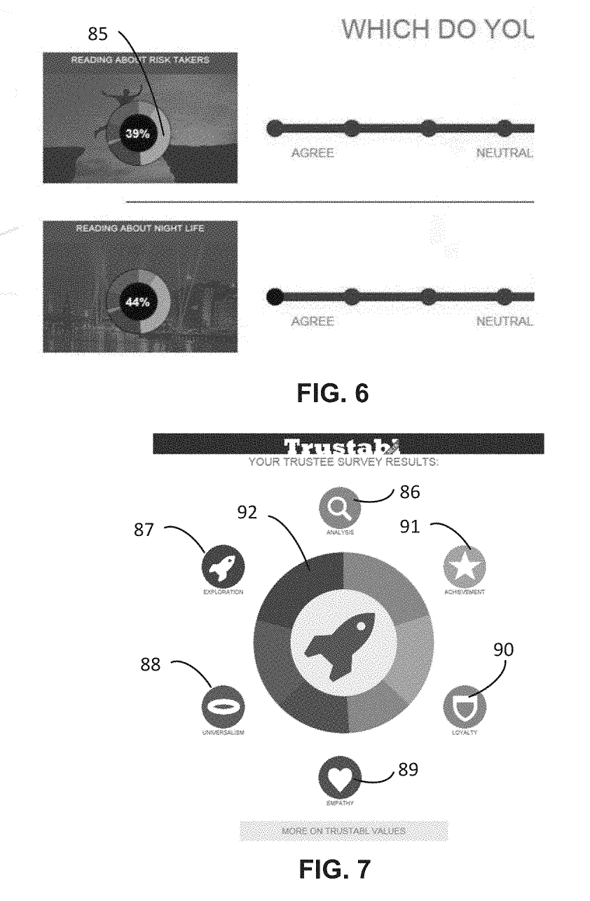

In an embodiment, a user must simply select one of the seven locations 81 and 82 located between both images. Here seven locations are given simply as a matter of choice. As shown at FIG. 6, a user can be then given the color code and the mark value levels 85 once a bullet is selected. In one embodiment, 10 or 20 questions are asked of the user. As explained above, such a tool to help associate a user with values and the mask is only one of multiple embodiments of the present invention.

Service Provider Solution

In addition to providing a service in the form of an HTML-based website, what is also contemplated is using this technology directly to help improve already existing websites and databases with content to be delivered to users using indexing tools, such as topic-based indexing, popularity-based indexing, sharing-based indexing, or uniqueness-based indexing. This kind of model contemplates using alone or in conjunction with other tools a values-based indexing tool.

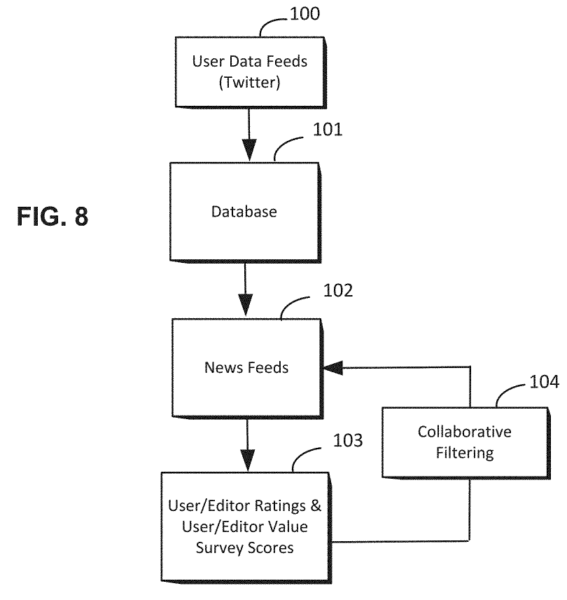

For example, a news outlet may have its own website with video, text, or other news stories already indexed and delivered to those browsing on the site. The goal of this technology as shown at FIG. 8 is to create pathways in data that can be mapped from external sources or databases. For example, by looking at user data feeds 100 as shown at FIG. 8, a plurality of users may be given some of the values in the form of a mask, a template, or a filter as shown above. For example, a handful of twitter users can be defined as Analysis type people. These feeds are then analyzed and each news story or content referred of interest will be linked with this type of value. This information will then be assembled in the form of a database 101. This information will then be used to map existing news feeds 102 and will then be reindexed using new values based on values 103. This process of news feeds 102 to scores 103 can be done with multiple types of collaborative filtering 104.

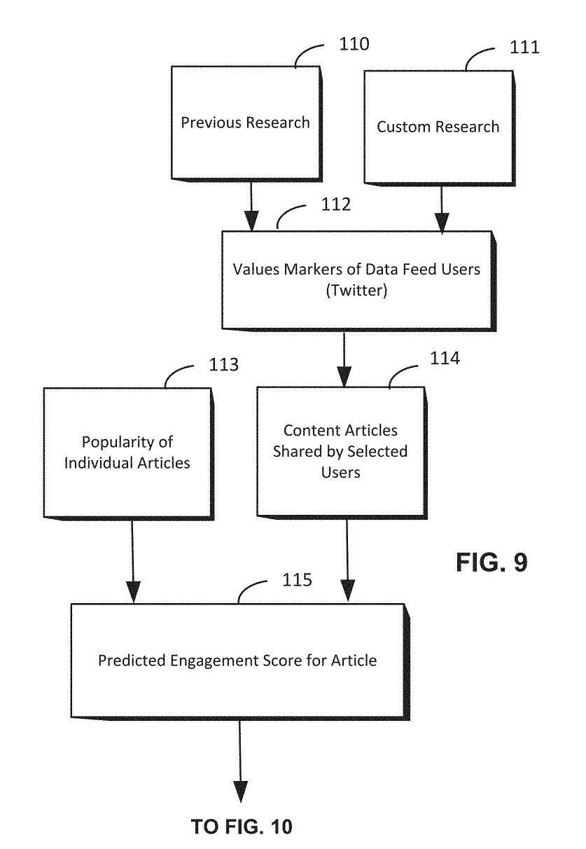

As shown with greater detail at FIG. 9, research can be used 110 or 111 to help generate values markers (i.e. those with strong dispositions to a specific value and considered as markers in a value) based on their data feed 112. The data of these markers 112 can then be used as content 114 to help agglomerate a pool of data for processing using data in a Natural Language Processing (NLP) or other type of data mining tool.

An expert in the field of value typing identifies thoughts leader of a particular type of value or plurality of value types. The thought-leaders twitter feeds (and/or other sources of media content) are analyzed for popularity amongst its respective audiences. Assuming basic thresholds of popularity are met, the content of the media is analyzed via NLP and sentiment analysis to determine relevant topics, subject (or entities), respective directed-sentiment and other semantic markers. This targeted analysis populates an adaptive value-typing engine. Content from a provider (customer) is analyzed via NLP and sentiment analysis to determine the matching value-types as determined by the value-typing engine. Engagement from value-typed users (as determined by the content they historically engage in) is ranked to further refine the value-typing engine.

As shown at FIG. 9, other indexing tools like the popularity of articles 113 can also be merged into the algorithm 115 alongside the values articles 114. For example, if an article has key words which is often cited by a specific value marker and also this same article is very widely read and popular, at 115, the predicted engagement score will be high.

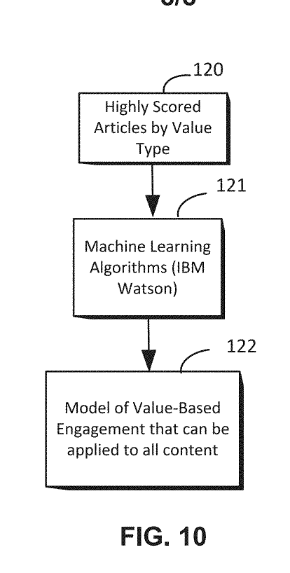

In one embodiment, tools like IBM Watson® can be used as shown at FIG. 10 as 121 to help highly scored articles 120 into the model of value-based engagement that can be applied to all content 122. For example, IBM Watson may note that Analytical Markers (i.e. Twitter followers of the Analytical type) will love the words “polls” or “statistically” or “average” and their social media posts will include these key words, then the learning algorithms will start with highly scored articles 120 and then produce a enhance model 122 based on all content.

What is contemplated is a platform with a computer-implemented software system for the enhanced filtering and indexing of news feed based on value-based markers, the platform comprising, a module to determine a number of value-based parameters, an association module using the module to determine the value-based parameters to a number of social media markers, a module to upload data content linked with each of the social media markers into a database, a module to use a Natural Language Processing software to mine the database content and associate key metrics and filtering to the different articles of the database, and a module to use the key metrics alone or in conjunction with other indexing metrics to rank news stories in a third party database.

The Systems and methods of the present invention may be embodied in various forms, including, for example, a data processor, such as the computer that also includes a database. Moreover, the above-noted features and other aspects and principles of the instant disclosure may be implemented in various environments. Such environments and related applications may be specially constructed for performing the various processes and operations of the instant disclosure, or they may include a general-purpose computer or computing platform selectively activated or reconfigured by code to provide the necessary functionality.

Whereas particular aspects of this invention have been described above for purposes of illustration, it will be evident to those skilled in the art that numerous variations of the details of the present invention may be made without departing from the invention.

Network and communication between the various modules may include, alone or in any suitable combination, a telephony-based network, a local area network (LAN), a wide area network (WAN), a dedicated intranet, the Internet or World Wide Web, a wireless network, a bus, or a backplane. Further, any suitable combination of wired and/or wireless components and systems may be incorporated into the network. Moreover, the network may be embodied as bi-directional links or as unidirectional links.

The processes disclosed herein are not inherently related to any particular computer or other apparatus, and may be implemented by a suitable combination of hardware, software, and/or firmware. For example, various general-purpose machines may be used with programs written in accordance with the instant teachings, or it may be more convenient to construct a specialized apparatus or system to perform the required methods and techniques.

Apparatus, systems and methods consistent with the instant disclosure also include computer-readable media (or memory) that include program instructions or code for performing various processing device-implemented operations based on the methods and processes described herein. The media and program instructions may be those specially designed and constructed for the purposes of the instant disclosure, or they may be of the kind well known and available to those having skill in the computer software arts. Examples of program instructions include, for example, machine code, such as produced by a compiler, and files containing a high-level code that can be executed by the computer using an interpreter.

While particular preferred embodiments have been shown and described, it is to be understood that the foregoing description is exemplary and explanatory only and is not restrictive of the instant disclosure. Those skilled in the art will appreciate that changes and additions may be made without departing from the instant teachings. For example, the teachings of the instant disclosure may be directed to various combinations and sub-combinations of the disclosed features and/or combinations and sub-combinations of several further features described herein. It is therefore contemplated that any and all modifications, variations or equivalents of the above-described teachings fall within the scope of the basic underlying principles disclosed above and claimed herein.

1. A system for providing enhanced filtering and indexing of digital content based on value-based parameters, the system comprising:
a processing engine and an application server communicatively coupled together; a client device communicatively coupled to said engine and said application server;
wherein said application server is configured to render a graphical user interface; wherein the said system is configured to implement:
a value module configured to determine a number of value-based parameters;
an association module configured to align the value-based parameters to a number of social media markers;
an data module configured to upload content linked with each of said social media markers into a database; wherein
the processing engine communicatively coupled with the value model, the association module and the data module uses a Natural Language Processing algorithm to associate and filter value based content of the database; and
a ranking module configured to rank content based on the value-based parameters in a third party database; wherein
the system is configured to output customized content to a user based on the value-based parameters.

2. A computer implemented method for providing enhanced filtering and indexing of digital content based on value-based parameters, the method comprising the steps of:
configuring a value module to determine a number of value-based parameters;
configuring an association module to align the value-based parameters to a number of social media markers;
configuring a data module to upload content linked with each of the social media markers into a database; wherein
the processing module uses a Natural Language Processing software to associate and filter value based content of the database; and
configuring a ranking module to rank content in a third party database; and configuring the system to output customized content to a user based on the value-based parameters.

3. The system of claim 1, wherein the value based parameters further comprises of various categories of value based attributes.

4. The system of claim 3, wherein the value based attributes consists of Analysis value, Achievement value, Loyalty value, Empathy value, Universalism value, Exploration value.

5. The system of claim 1, wherein the processing module uses Natural Language Processing by leveraging dependencies and semantic similarity between contents in order to find a latent structure in the pattern of the content.

6. The system of claim 1, further configured to provide an user option to select the content based on the category.

7. The system of claim 1, wherein the content rendered on the graphical user interface can dynamically evolve to adapt to an user choice of category.

8. The method of claim 2, wherein the value based parameters further comprises of various categories of value based attributes.

9. The method of claim 8, wherein the value based attributes consists of Analysis value, Achievement value, Loyalty value, Empathy value, Universalism value, Exploration value.

10. The method of claim 2, wherein the processing module is configured for Natural Language Processing by leveraging dependencies and semantic similarity between contents in order to find a latent structure in the pattern of the content.

11. The method of claim 2, further configured to provide an user option to select the content based on the category.

12. The method of claim 2, wherein the content rendered on the graphical user interface is configured to dynamically evolve and adapt to an user choice of category.
